(19) United States
(12) Patent Application Publication
(10) Pub. No.: US 2009/0026320 A1
(43) Pub. Date: Jan. 29, 2009

(54) Fighting Kite

(76) Inventor: Gerard Borromeo, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 11/829,290

(22) Filed: Jul. 27, 2007

(51) Int. Cl. B64C 31/06

(52) U.S. Cl. 244/153 R

(57) ABSTRACT

A kite is particularly adapted for acrobatic flight maneuvers in preferred embodiments by a protruding nose section that extends outwards from a frame covered by a tensioned lightweight skin. In competitive combative flight with similar kites, a diving maneuver is used to drive the nose section downward to puncture the skin of the opposing players kite, thus downing it.

### CROSS REFERENCE TO RELATED APPLICATIONS

None

### BACKGROUND OF INVENTION

The present invention relates to kites, and in particular highly maneuverable acrobatic kites.

A kite is light weight assembly of one or more wing like surface that is teathered to the ground. The lift necessary to fly the kite, which would otherwise fall being heavier than air is generated when air flows across the wing like surface. The air flow from wind creates low pressure above the kite and high pressure below it, providing the necessary lift. The air flow from the wind, in addition to generating lift, also produces a horizontal drag along the direction of the wind, producing tension on the tether line that is generally held by the operator to control the kite and prevent it from flying away.

Kites and kite flying are truly an ancient form of art, yet still remains a vibrant game for children, as well as a sport and form of entertainment for many people and cultures around the world. However the sport of kite flying is generally limited to days and locations with high enough winds. Generally, the lighter the wind the more skill is required to launch and fly a kite, which can be very frustrating for younger or smaller children. Moreover, owing to the limited maneuverability of kites that are less expensive and easier to fly, wide open spaces are required, least the kite became ensnarled and damaged in trees and building or utility infrastructure. Such suitable areas for kite flying are becoming increasingly scarce in urban areas, where the kite flyer increasing competes for spaces with others seeking different forms of recreation.

While kites have been used in warfare as signal means, the principle modern uses are recreation, as well as art in the form of aerial ballet art. Modern kites include may include multiple tether line for steering and control, depending on the complexity of the wing assembly and shape. Multi-line steerable kites that generate excess force have been developed for the sport of kite surfing, kite landboarding or kite buggying.

Such power or acrobatic kites may use two or four lines to delicately control the kite's angle to the wind. Also known are traction kites that have an additional line to de-power the kite and act as a quick-release mechanism for emergency situation to release the kite from the flyer.

The sport of kite fighting though ancient remains popular in Asia. Kites for such combat tend to be small and flat and generally diamond shaped. They are typically constructed of bamboo and paper, with a tapered bamboo spine and a balanced bow. Tails while common on recreation kites for stability, are omitted to enhance agility. A portion of the tether is coated with an abrasive composition sufficient to cut the tether of another cut. Thus, the object of such combat is to maneuver the kite such that cutting section of the tether rubs against that of the opponent flat kites have a length of cutting line coated with an abrasive attached to the bridle, which is then tied to a light cotton flying line. Presumably, such kites are capable of generating high enough speed or force during flight such that the abrasive on one tether can cut through the other tether. However, in such combat the cutting the opponents cord will likely lead to the kite being carried away by the wind in which case it can easily be either lost or seriously damage in an uncontrolled landing

It would be desirable to have other means of kite fighting for recreation and competitive sport. It would be desirable to have fighting kites that are highly maneuverable, in which the mode of combat depends on the users flying skills, but that are relatively simple to in construction such that they can be either of low cost or readily repaired, as such combat inherently results in some damage to the kite.

It would also be desirable to have a form of kite combat wherein the kite is not lost or totally damaged when the opponent is victorious.

It is therefore a first object of the present invention to provide a kite that is easier to fly and control in light winds,

It is also an object of the invention to provide a kite that is highly maneuverable yet of simple construction such that it can be flown in complex acrobatic maneuvers with a single string.

It is a further object of the invention to provide a kite compatible with an alternative means of fighting or combat with similar kites as sport wherein the kite is less likely to be totally destroyed or lost, and can be readily repaired.

### SUMMARY OF INVENTION

In the present invention, the first object is achieved by providing a kite with a substantially flat frame portion, a lightweight skin covering at least a portion of said substantially flat frame portion, and a narrow nose portion protruding outward from the forward end of said substantially flat frame.

A second aspect of the invention is characterized in that the kite also has a substantially flat frame portion has a concave shaped aft portion opposite said narrow nose.

A third aspect of the invention is characterized in that the kite also has an opening in the skin just forward of the concave aft section that is preferably sickle or falcate shaped.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a plan view of the frame of the kite.

FIG. 1B is a front elevation of the frame of the kite.

FIG. 1C is side elevation of the spline of the kite.

FIG. 2A is a perspective view from above the kite of FIG. 1 showing the portions of the skin attached to the frame.

FIG. 2B is a perspective view from below the kite of FIG. 1 showing the portions of the skin attached to the frame.

FIG. 3 is a perspective view from the ground of a downward attack by the upper kite on the lower kite.

FIG. 4 is a perspective view from mid air between the lower and upper kite of an upward attack by the lower kite.

FIG. 5A is plan view of an embodiment of the nose section of the kite

FIG. 5B is a side elevation of the nose section of the kite in FIG. 5A

FIG. 5C is a cross-sectional elevation of the kite in FIG. 5A taken at section line C-C.

FIG. 6A is a plan view of the frame of another embodiment of the kite.

FIG. 6B is a front elevation of the frame of the kite in FIG. 6A

FIG. 6C is side elevation of the spline of the kite in FIG. 6A

FIG. 7 A is a plan view from above another embodiment of the kite.

FIG. 7B is a side elevation view of the spline of the kite in FIG. 7A.

FIG. 8A is plan view of an embodiment of the nose section of the kite

FIG. 8B is a side elevation of the nose section of the kite in FIG. 8A, but with the portion corresponding to section line B-B in FIG. 5A being a cross-section.

FIG. 8C is a cross-sectional elevation of the kite in FIG. 8A, taken at section line C-C.

FIG. 9A is plan view of an embodiment of the nose section of the kite,

FIG. 9B is a side elevation of the nose section of the kite in FIG. 9A, but with the portion corresponding to section line B-B in FIG. 5A being a cross-section.

FIG. 9C is a cross-sectional elevation of the kite in FIG. 9A taken at section line C-C.

### DETAILED DESCRIPTION

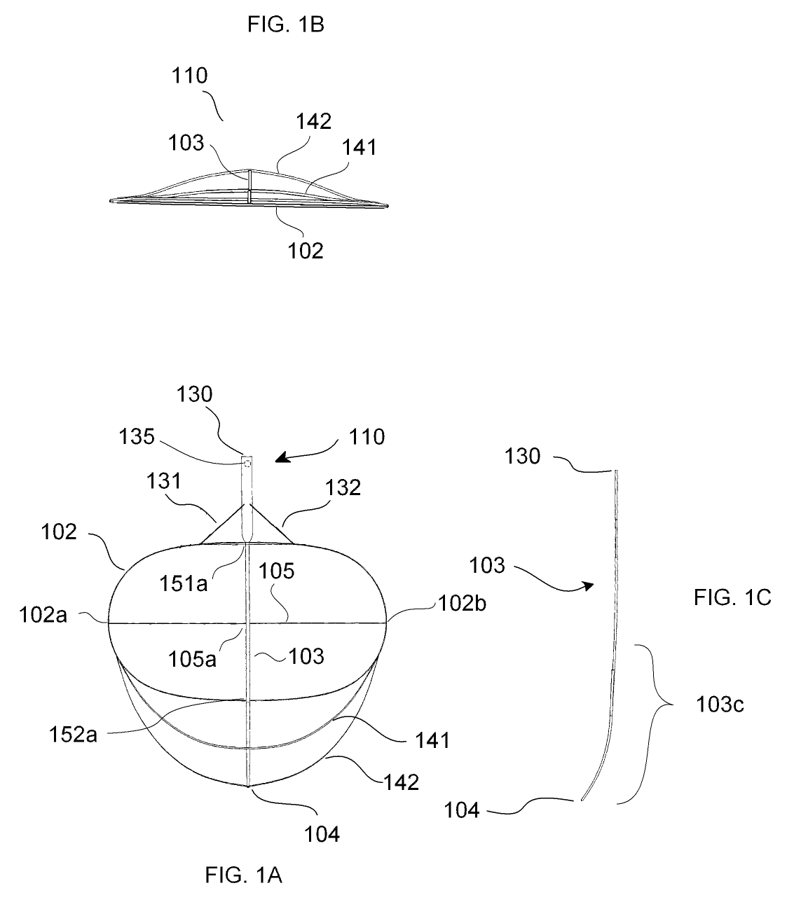

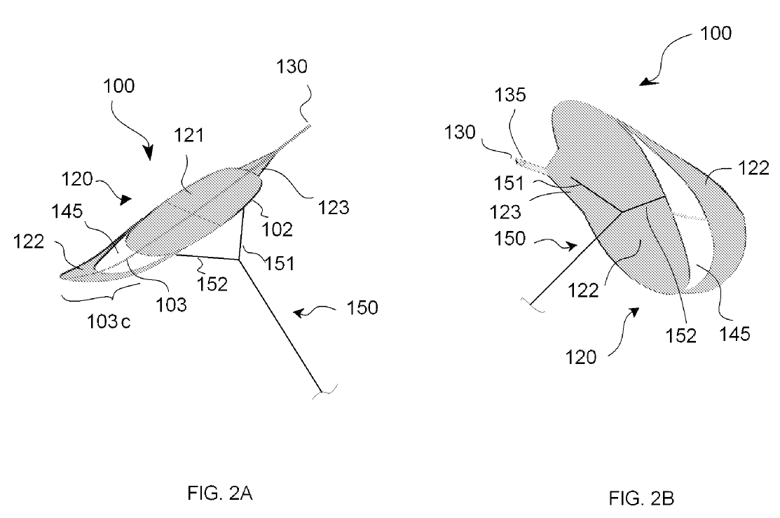

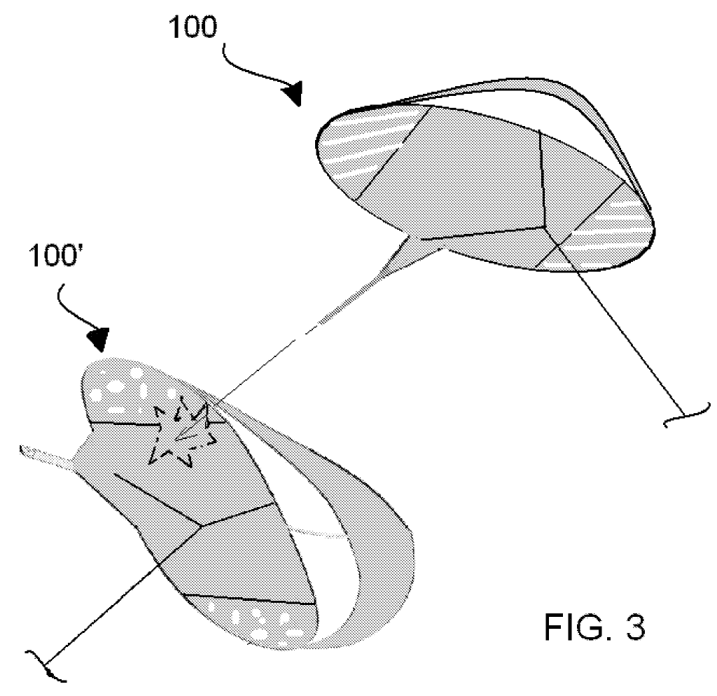

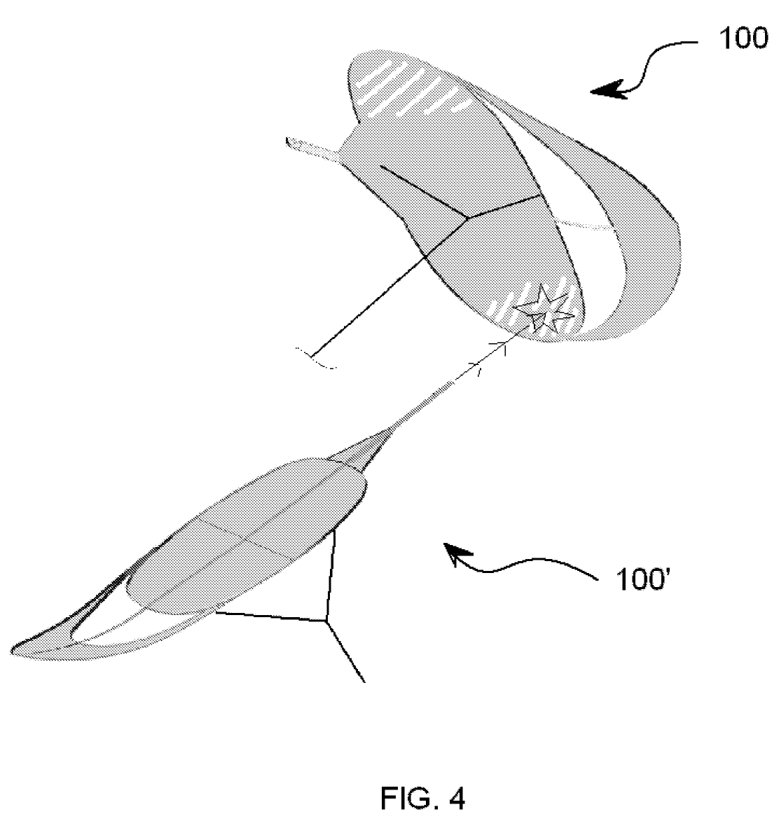

Referring to FIGS. 1 through 9, wherein like reference numerals refer to like components in the various views, there is illustrated therein a new and improved kite capable of fighting maneuvers with like kites, generally denominated 100 herein. The basic structure of the kite will be described with respect to FIGS. 1, 2 and 5-9, whereas the means and methods of combat will be described with respect to FIGS. 3 and 4.

In accordance with the present invention, fighting kite 100 comprises a frame 110, with a lightweight skin 120 extending over at least a portion of the frame 110, and a protruding nose section 130.

Frame 110 is formed in part preferably from an oval loop 102 and a linear spline 103. The spline 103 bisects the principle axis of the oval loop 103. Moreover, as can be seen in the elevation of the spline in FIG. 1C, the spline 103 is preferably curved at the rearward portion, with the front portion of the spline 103 being flatter and forming the protruding nose section 130. Generally the spline should curve at least about 2.5″, but is more preferably about 3.5″.

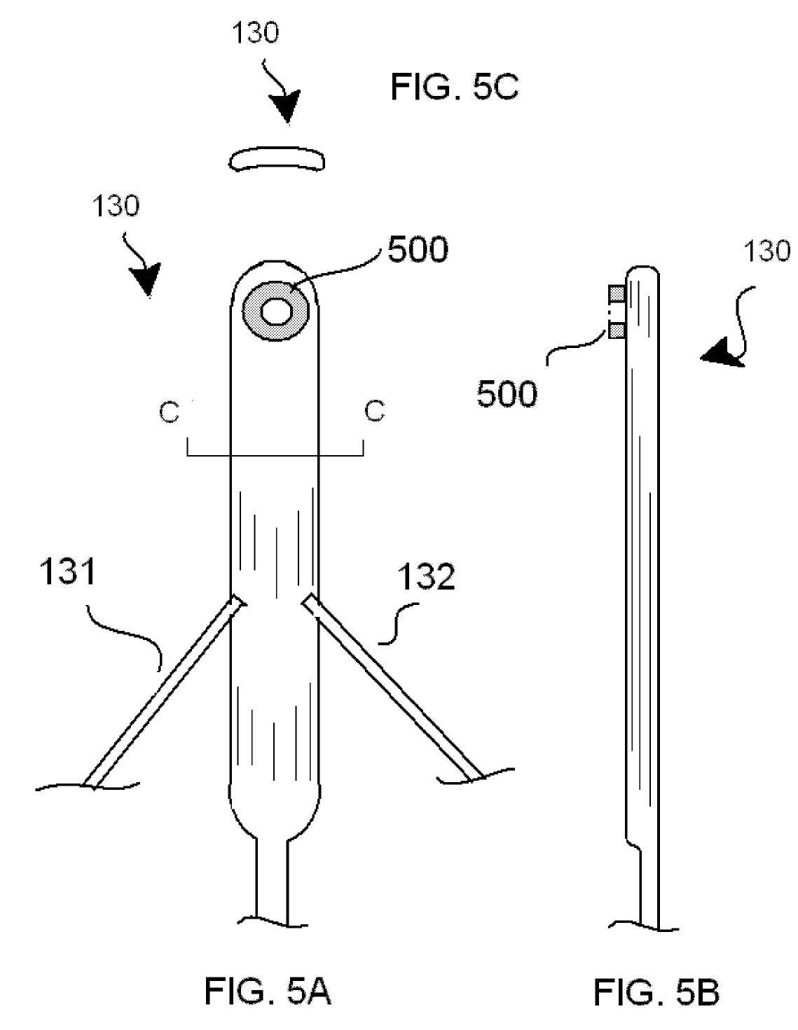

The protruding nose section is used for combat with other kites having the same capability, as will be discussed in greater detail with respect to FIGS. 3 and 4. It should noted in the plan view of the frame in FIG. 1A, and the more detailed drawings of the nose in FIGS. 5, 8 and 9, that the spline is wider at the nose section but then narrows. Thus, the nose is more rigid than the other portions of the spline 103. In the preferred embodiments the spline is bamboo and the wider nose portion thereof is about 30 mm wide by about 4-5 mm thick (an aspect ratio of about 6 to 8:1), in a kite with a span of about 36 in. (91 cm) perpendicular to the direction of the nose 130. The mid section of the spline 103 is about 10 mm wide and 4 mm (an aspect ratio of about 2.5:1) whereas the curved aft section of the spline opposite the nose is about 9 mm wide and 1 mm thick (an aspect ratio of about 9:1). It should thus be appreciated that the aft section of the kite is more flexible than other portions owing to the above tapering or variations in the spline 103 starting from the nose 130. Thus, the spline 103 is preferably curved to provide a concave shaped aft portion 103c of the frame for the highest performance.

It will be appreciated by one of ordinary skill in the art that largely suitable alternatives to bamboo for constructing the frame are likely to include one or more of fiberglass, plastic, carbon fiber reinforced resin and the like, for at least some if not all of the frame structure.

The aft section of kite 100 is formed by a first arcuate segment 141 extending from the rearward portion of the oval loop 102. A second arcuate segment 142 extends rearward past the first arcuate segment 141. Each arcuate segment is connected to the corresponding intersection with spline 103, preferably with a combination of multiple wraps of strong twine or thread and adhesive or resin encapsulating the same.

The lightweight skin 120 is formed of a first portion 121 that covers at least the oval loop 102 and a second portion 122 that cover the portion of the frame 110 between the first arcuate 141 and the second arcuate segment 142, leaving an aperture 145 there between. The aperture 145 in the skin just forward of the concave aft section is preferably sickle shaped (falcate), owing to the curvature of arcuate segments 141 and 142. A presently preferred material for forming skin 120 is polyester film, with alternatives including metallized polyester film, paper, rice paper, tightly woven fabric and the like.

Oval loop 102 is preferably formed by bending a flexible flattened rod or stick of a strong lightweight material, such as bamboo, in the axis perpendicular to the width of the rod. More preferably a string 105 is used to form oval loop 103 by bending a flattened strip of bamboo from the midsections to join the ends. Thus string 105 extends across to the width of the oval 102 and is tied to both the midpoint 102a and the connected ends 102b. Most preferably, the string 105 is also wrapped around the intersection 105a with the spline 103 in the center of the oval 102 to form a strong connection thereto. Tensioning the oval 102 portion of the frame with the segments of string 105 on opposite sides of spline 103 results in a slight upward concavity transverse to the spline 103, as can be seen in FIG. 1B.

Preferably, the skin 120 also has a deltoid forward section 123 that extends forward from the fore portion of oval loop 102 and extends to diagonal struts 132 and 133 that extend from about the mid section of nose 130 until the point of connection with the neighboring portion of the oval loop 102.

On the bottom side of the kite 100 are strings 151 and 152 that meet at a common junction that is attached to the tether or fly wire 150. It is preferred that the lateral position of this junction is at the center of gravity of kit 100. Tether 150 then extends to the ground and is held by the handler/flyer. It is preferable to use a rather strong 80 lbs. (36.3 kg) test line for the tether.

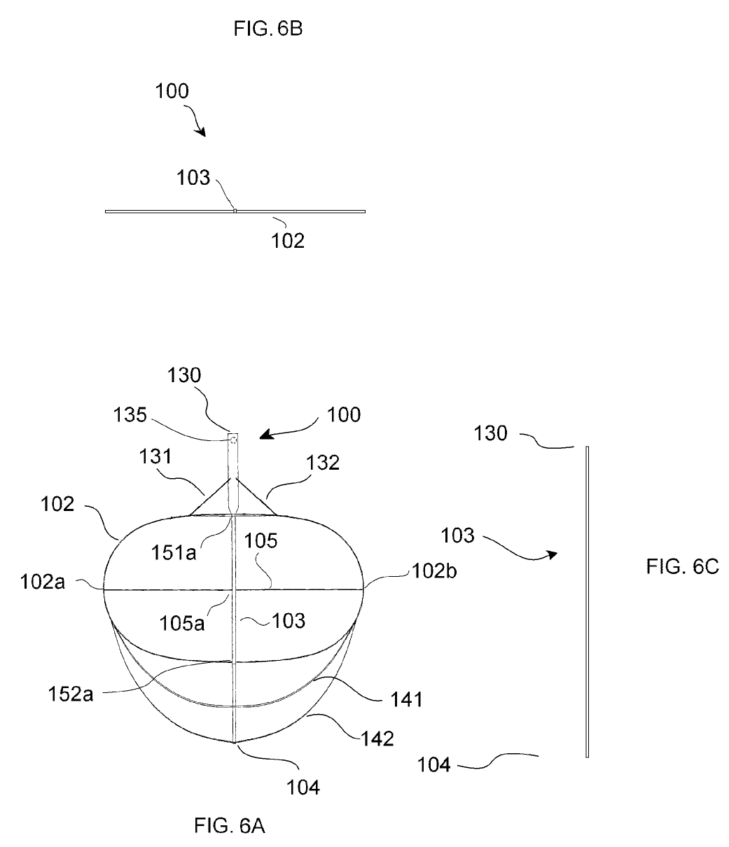

FIGS. 6A, B and C illustrates the frame of another embodiment of the kite. It should appreciated that as the spline is not curved in this embodiment the kite is not stable in very light winds and is not capable of the maneuvers and control with one string described with respect to the other embodiments. However, this kite being generally more stable in higher winds, requires less skill and experience to fly.

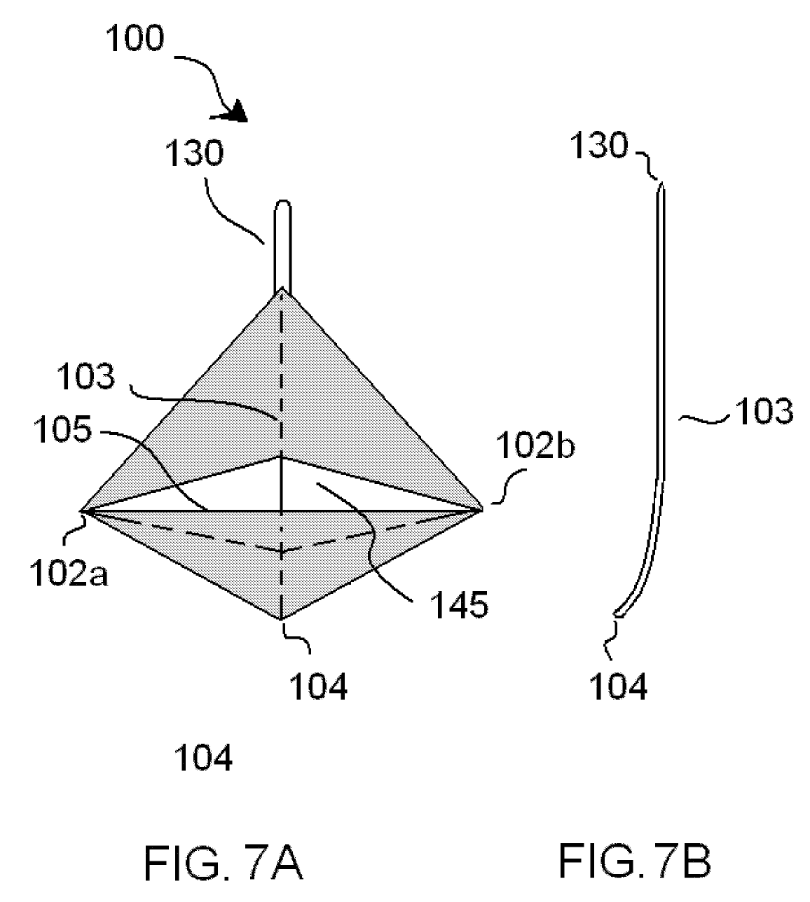

While the shape of the frame 102 is preferably fan shaped or flabellate, alternatively it can be deltoid shaped as shown in FIG. 7. In this non-limiting embodiment the nose 103 is at least partly covered by the wing like skin portion.

It is also preferred that the nose is heavier than other portions of the spline. This can be accomplished in a number of alternative ways, the description of which is not intended to be non-limiting as to the scope of the appended claims.

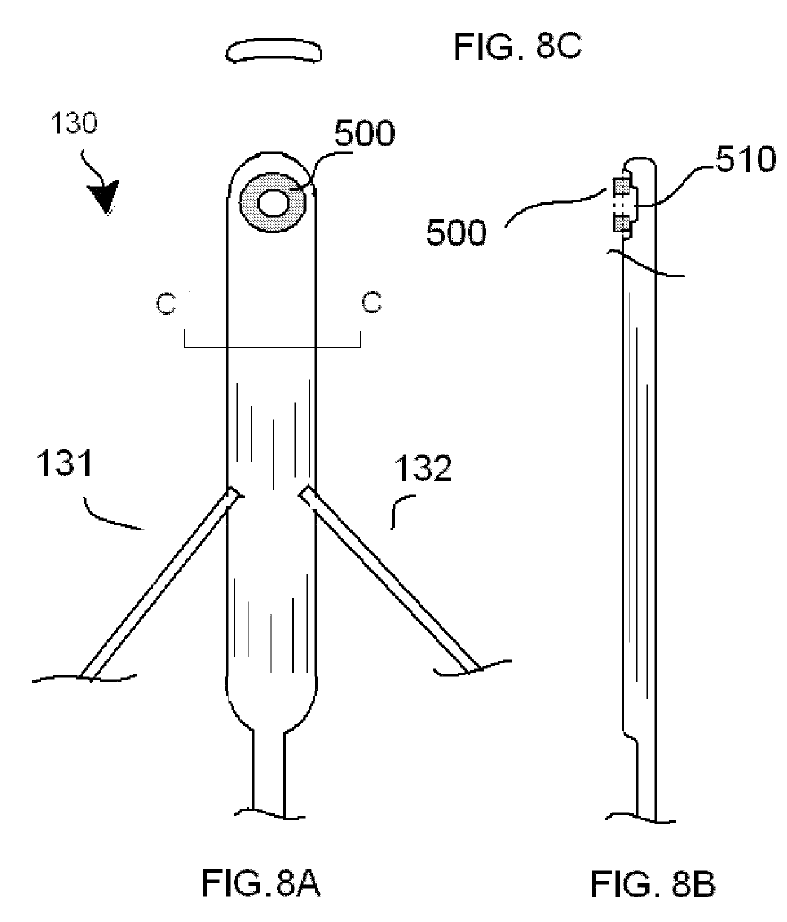

First, it should be appreciated that depending on the dimensions of the nose versus the rest of the spline 103 and the materials of construction, this may readily provide a heavier nose. As for example the nose may be constructed, of a denser material than the remainder of the spline 103. Alternatively, weights 500 may be added to the nose as shown in FIGS. 5, 8 and 9. Such weights 500 may be glued or adhered to the nose, or embedded in the nose. In FIG. 8, one or more weights 500 optionally are placed and held in a pocket 510 formed in the front of the nose. In any of the other embodiments, the weights 500 may be held in place either permanently or temporarily with glue, tape, adhesive, mechanical fasteners and the like

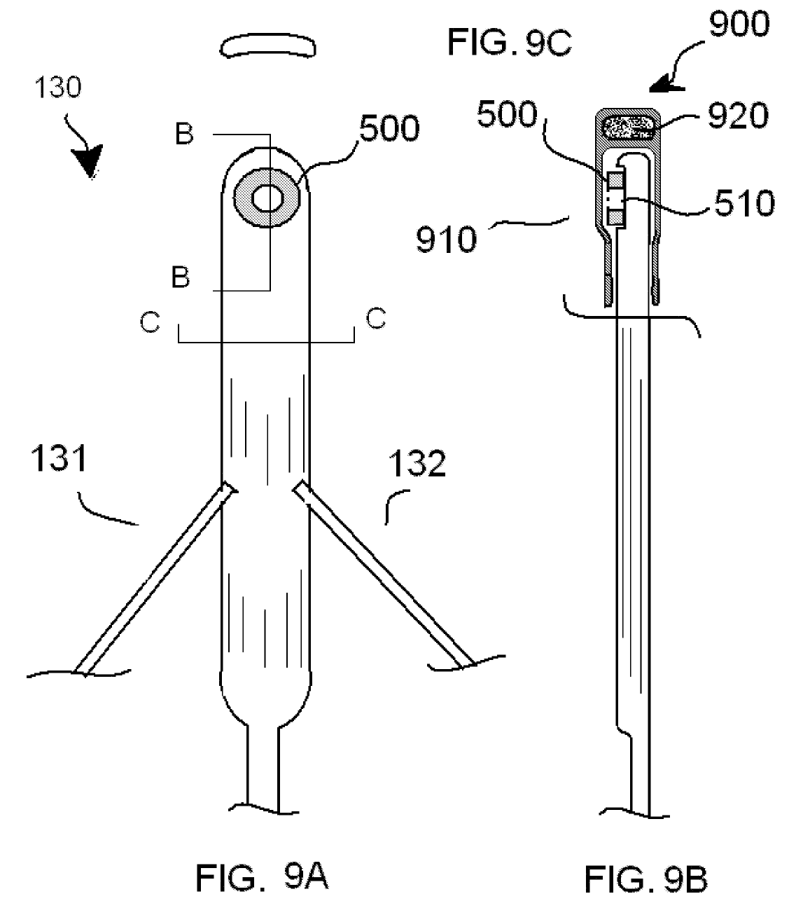

It is more preferable that the quantity of weights in the nose is variable. As illustrated in FIG. 9, it is most preferable that the weights are held onto the tip of the nose in an elastic rubber sleeve 900 that fits over the tip nose 103 and tightly secures an inserted weight, such as one or more coins, tokens or washers and the like, to the nose 103. The cylindrical open portion 910 of sleeve 900 is elastic such that contracts around the portion of nose 103 housing weights 500, securing them in place, Optionally, the front of sleeve has a foam or resilient padding 910 soft that it is optionally soft, but depending on the anticipated usage and the skin material of other kites that it is intended to tear or fracture in combat.

For a bamboo kite according to the dimension describe above an appropriate range of weight is about 1.5 to 3 additional grams, which is easily provided with one or more metal washers about 1 mm thick with an outer diameter of about 20-25 mm and an inner diameter of about 10 to 15 mm respectively. It should be appreciated that the nose itself may include weights or be deliberately constructed to provide additional weight.

A kite constructed according to the description and drawings of FIGS. 1, 3 and 5-7 has numerous aerodynamic advantages with respect to the recreational capabilities as well as the suitability for the combat mode of play described with reference to FIGS. 3 and 4. Moreover, owing to the inherent unpredictability of predetermining the largely wind driven flight characteristic of an un-propelled aerial vehicle such as a kite, the stability and maneuverability described below were surprising unexpected.

First, the kite 100 is capable of relatively low level flight, which coupled with the characteristic that it can be flown on a very short cords, simplifies launching for children, novices or those with limited fitness. It is also permits the kite 100 to be used in what would be consider less than ideal conditions, closer to trees and building, it being suitable for small spaces.

The kite 100 is also capable of flight in lighter winds, typically as low as about 5 to 10 mph, expanding the opportunities for recreation to almost all weather conditions. Conventional diamond shapes kites requires winds of at least 10 mph, preferably about 15 mph. Box kites, such as those used in traditional kite fighting in Asia require a minimum wind speed of about 15 mph. The kite 100 is also capable of horizontal and vertical flight. That is the kite can fly parallel to the ground with the wings pointed vertically.

Kites with thicker and less flexible bamboo in the oval section are inherently less stable which is actually desired when the kite is intended to be used for fighting. Such instability enables full control with a single string or tether. Kites made with thinner or more flexible bamboo in the oval portion tend to be more stable. When the various embodiments of the invention are implemented to provide a fighting kite, generally the bamboo in the oval section preferably has a thickness of about 0.5 mm, reducing the thickness by about 25% to about 3.5 to 4 mm improves the kite stability. Such a kite being more stable requires less skill to fly, but is also less maneuverable.

Further, and of great significance for aerial combat with other kites, the fighting kite having the more rigid oval can be controlled with a single string Further, the kite is readily steering by first pulling on the tether which causes the nose to tilt upward. Then, partially releasing the tether so that it is slack causes the nose to sway or wobble between left and right orientation. When the nose is pointed in the desired direction tone then pulls on the tether causing the kite to stabilize and then fly in the direction it is pointed. Thus, a jerking motion on the string, followed by a rapid release causes the kite 100 to dive as shown in FIG. 3, to attack a lower kite.

Further, the selected of the weight on the nose provides for variable controllability appropriate to skill level, the more maneuverable kite with a greater weight on the nose being less stable and hence requiring more practice and skill to fly. This provides the opportunity for owner or user of the kite to continuously develop a higher skill level by adding weight as they gain mastering of the kite with lower weights when it is more stable, but less maneuverable.

Further, as the method of combat largely merely punctures the skin, causing the kite to loose lift and gently fall, the kit is not lost, and can generally be landed safely in an open area when the user is alert. Depending on the extent of the damage, the user can repair the kite themselves. Further, as the kite has a simple construction it is less costly to replace or repair.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A kite that comprises:
a) a substantially flat frame portion,
b) a lightweight skin covering at least a portion of said substantially flat frame portion, and
c) a narrow nose portion protruding outward from the forward end of said substantially flat frame.

2. A kite according to claim 1 wherein said a substantially flat frame portion has a concave shaped aft portion opposite said narrow nose.

3. A kite according to claim 1 comprising an opening in the skin just forward of the concave aft section.

4. A kite according to claim 2 comprising an opening in the skin just forward of the concave aft section.

5. A kite according to claim 3 wherein the opening in the skin just forward of the concave aft section has a falcate shape.

6. A kite according to claim 4 wherein the opening in the skin just forward of the concave aft section has a falcate shape.

7. A kite according to claim 5 wherein the frame has an oval shape.

8. A kite according to claim 6 wherein the frame has an oval shape.

9. A kite according to claim 1 further comprising strings that downwardly descends from the forward and aft portion of the frame and joins with a tether string at substantially the center of gravity of the kite.

10. A kite according to claim 1 wherein the nose is heavier than the frame such that the center of gravity of the kite is forward of the geometric center.

11. A kite according to claim 1 wherein the weight are detachable to vary the acrobatic performance of the kite.

12. A kite according to claim 1 wherein the weight are held in an elastic sleeve that is inserted over the nose of the kite.

13. A kite according to claim 1 wherein the nose has elastic padding

14. A kite according to claim 9 wherein the sleeve has elastic padding dispose over the nose.

15. A kite according to claim 1 wherein the nose is more rigid than the other portions of the spline 103.

16. A kite according to claim 15 the greater flexibility aft of said nose is provided by a tapering thickness in the spline

17. A kite according to claim 2 wherein the nose is more rigid than the other portions of the spline 103.

18. A method of play, the method comprising the steps of:
a) providing at least a first and second kite that each comprises;
i) a substantially flat frame portion,
ii) a lightweight skin covering at least a portion of said substantially flat frame portion, and
iii) a narrow nose portion protruding outward from the forward end of said substantially flat frame.
b) flying the first and second kites,
c) driving at least one of the first and second kites downward whereby the nose of one kite puncture the skin of the other kite to down it.

19. A method of play according to claim 18 wherein the substantially flat frame portion at least one of the first and second kite has a concave shaped aft portion opposite said narrow nose.

20. A method of play according to claim 19 wherein the substantially flat frame portion at least one of the first and second kite has an oval shape and further comprises a falcate shaped opening in the skin just forward of the concave aft section.
